(19) United States
(12) Patent Application Publication
(10) Pub. No.: US 2004/0061826 A1
(43) Pub. Date: Apr. 1, 2004

(54) Display system using a hologram pattern liquid crystal

(75) Inventor: Chan Young Park, Seoul (KR)

Correspondence Address: FLESHNER & KIM, LLP, P.O. BOX 221200, CHANTILLY, VA, 20153, US

(73) Assignee: LG ELECTRONICS INC.

(21) Appl. No.: 10/662,316

(22) Filed: Sep. 16, 2003

(30) Foreign Application Priority Data
Sep. 17, 2002 (KR) P2002-56577

(51) Int. Cl. G02F 1/13

(52) U.S. Cl. 349/201

(57) ABSTRACT

A display system using a hologram pattern liquid crystal can adjust color and quantity of light selectively for each and every pixel. The display system includes a plurality of first electrodes formed in line in the same direction, a plurality of second electrodes formed in line in a direction perpendicular to the first electrodes, liquid crystals having hologram patterns formed in a pixel area between the first and second electrodes, an optical waveguide for transferring light to the pixel area, and a light source, located in a side area of the optical waveguide, for generating the light.

This application claims the benefit of the Korean Application No. P2002-56577 filed on Sep. 17, 2003, which is hereby incorporated by reference.

### BACKGROUND OF THE INVENTION

1. Field of the Invention

The present invention relates to a display system using a hologram pattern liquid crystal which can adjust color and quantity of light selectively for each and every pixel.

2. Description of the Related Art

Recently, a flat type display for implementing a thin and large-sized screen is being watched with keen interest in replacement of the existing Braun-tube display having a small-sized screen and a large-sized system.

Such a display panel is classified into an LCD (Liquid Crystal Display), PDP (Plasma Display Panel), etc., and at present, the LCD is generally being used.

FIG. 1 is a view illustrating the structure of a general LCD.

As shown in FIG. 1, a light source 1 is connected to a power supply unit 11 and generates light, and the generated light is incident to a light guide panel 2.

The incident light is reflected in the light guide panel 2, and then incident to a diffusion plate 3.

The incident light diverges from the diffusion plate 3 to having a uniform optical distribution factor, and then the phase of the light is compensated for through a compensation plate 4.

Thereafter, the phase-compensated light passes through a first polarization plate 5, a first electrode 6, a liquid crystal 7, a second electrode 8, a second polarization plate 9 and a protective plate 10 in order.

Here, if a video signal is inputted to a driving unit 12, the driving unit 12 applies a voltage to the first and second electrodes 6 and 8 located on upper and lower parts of the liquid crystal 7.

If the voltage is applied to the first and second electrodes 6 and 8, the liquid crystal 7 transmits the light with the quantity of light adjusted, so that the image is displayed.

However, the LCD having the structure as described above should use the first and second polarization plates 5 and 9, a color filter, etc., and this causes the structure of the LCD to be complicated with its light efficiency lowered.

### SUMMARY OF THE INVENTION

Accordingly, the present invention is directed to a display system using a hologram pattern liquid crystal that substantially obviates one or more problems due to limitations and disadvantages of the related art.

An object of the present invention is to provide a display system using a hologram pattern liquid crystal which has a simple structure and is suitable for a large-sized panel.

Another object of the present invention is to provide a display system using a hologram pattern liquid crystal which has an improved light efficiency.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a display system using a hologram pattern liquid crystal includes a plurality of first electrodes formed in line in the same direction, a plurality of second electrodes formed in line in a direction perpendicular to the first electrodes, liquid crystals having hologram patterns formed in a pixel area between the first and second electrodes, an optical waveguide for transferring light to the pixel area, and a light source, located in a side area of the optical waveguide, for generating the light.

The display system according to the present invention further includes a driving unit for driving the first and second electrodes, and a control unit for controlling the driving unit in accordance with a video signal inputted from the outside.

Here, the first and second electrodes are transparent electrodes, and the hologram pattern of the liquid crystal which is formed in one pixel is different from the hologram pattern of the liquid crystal which is formed in its neighboring pixel.

Also, one pixel may be divided into first, second and third sub-pixels, and the hologram patterns of the liquid crystals formed in the respective sub-pixels are different from one another.

Here, the liquid crystal of the first sub-pixel adjusts a quantity of transmitted light of a red light, the liquid crystal of the second sub-pixel adjusts a quantity of transmitted light of a green light, and the liquid crystal of the third sub-pixel adjusts a quantity of transmitted light of a blue light.

Also, if one light source is provided, a length of the light source is the same as a length of a side face of the optical waveguide, and if plural light sources are provided, the respective light sources are arranged corresponding to cores of the optical waveguide.

The optical waveguide is located on a lower part of the first electrode, the light source is located in a side area of the optical waveguide, and a reflecting mirror is located on the other side face of the optical waveguide.

Here, if the optical waveguide has one core for propagating the light, the core may be formed so that an area of the core is the same as that of the display panel having the pixels formed thereon, and if the optical waveguide has plural cores for propagating the light, the respective cores may be formed in the same direction so that they correspond to the first electrodes, respectively.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating the structure of a general LCD;

FIGS. 2 and 3 are views illustrating a display system using a hologram pattern liquid crystal according to the present invention;

FIGS. 4 to 6 are views illustrating diverse types of light source and waveguide of FIG. 2;

FIGS. 7A and 7B are views illustrating hologram patterns formed in the liquid crystal;

FIGS. 8A and 8B are views explaining the concept of driving a hologram pattern liquid crystal;

FIG. 9 is a view illustrating the implementation of gradation of a hologram pattern liquid crystal according to time; and

FIGS. 10A and 10B are views illustrating the implementation of color of a hologram pattern liquid crystal.

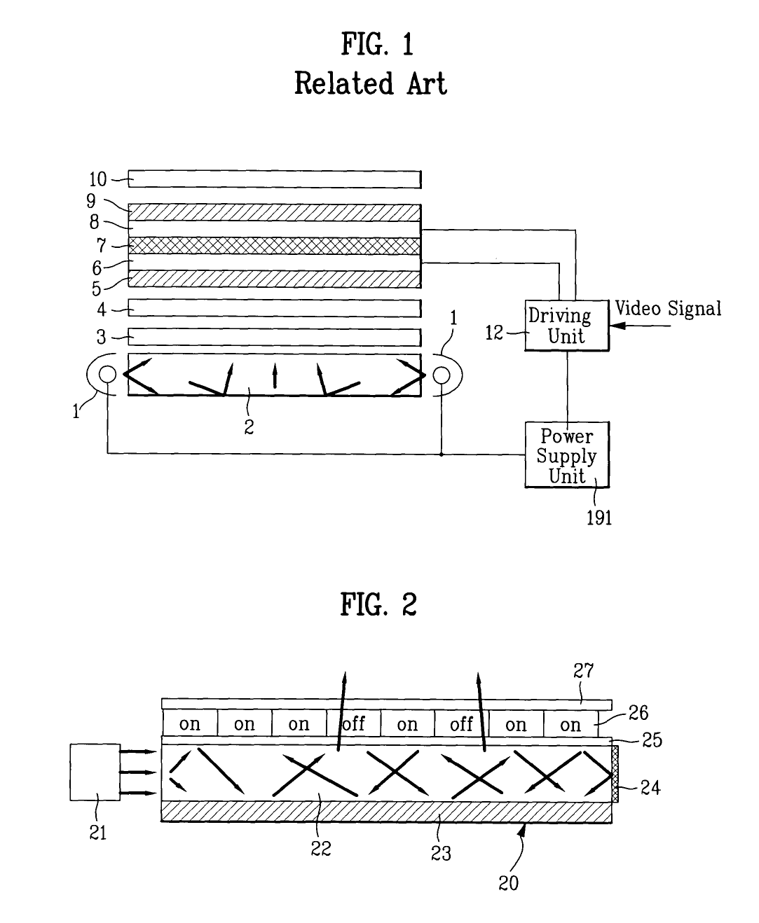

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

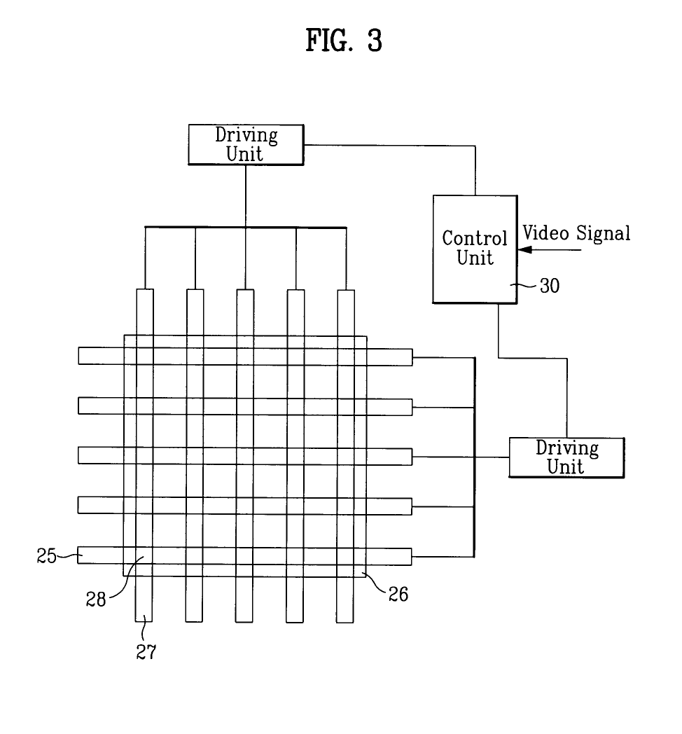

FIGS. 2 and 3 are views illustrating a display system using a hologram pattern liquid crystal according to the present invention.

As shown in FIG. 2, the display system according to the present invention includes a plurality of first electrodes 25 formed in line in the same direction, a plurality of second electrodes 27 formed in line in a direction perpendicular to the first electrodes, liquid crystals having hologram patterns formed in a pixel 28 area between the first and second electrodes 25 and 27, an optical waveguide 20 for transferring light to the pixel 28 area, and a light source 21, located in a side area of the optical waveguide 20, for generating the light.

The display system according to the present invention further includes a driving unit 29 for driving the first and second electrodes 25 and 27, and a control unit 30 for controlling the driving unit 29 in accordance with a video signal inputted from the outside.

Here, the first and second electrodes 25 and 27 are transparent electrodes, and the light source may comprise a high-voltage mercury lamp, metal halide lamp, white LED, etc.

The optical waveguide 20 is located on a lower part of the first electrode 25, and comprises a core 22 and a cladding 23 surrounding the core.

The light source 21 is located in a side area of the optical waveguide 20, and a reflecting mirror 24 is located on the other side face of the optical waveguide 20.

Generally, since the refraction index of the core 22 is greater than that of the cladding 23, the incident light is totally reflected to travel along the core 22.

The light traveling along the core 22 is reflected by the reflecting mirror 24, and then returns along the core 22.

At this time, since the incident light travels and returns along the core 22, the light efficiency and the brightness of a picture can be increased.

Meanwhile, there are many ways to make the light incident to the core 22 of the optical waveguide in accordance with the kind of the light source 21 and the shape of the core 22 of the optical waveguide.

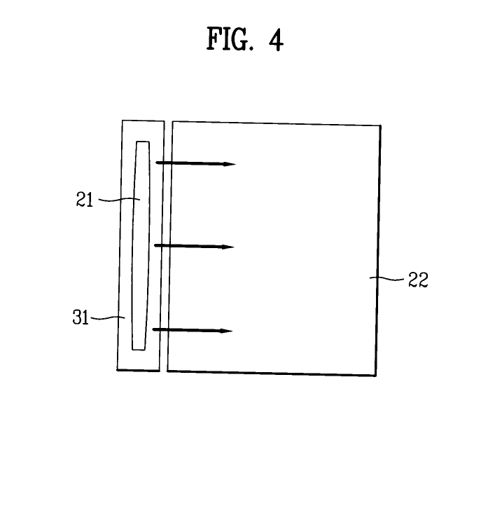

FIGS. 4 to 6 are views illustrating diverse types of light source and waveguide of FIG. 2.

In the embodiment of FIG. 4, there is one light source 21, and the length of the light source 21 is the same as that of a side face of the optical waveguide 20.

At this time, the optical waveguide 20 has one core 22 for propagating the light, and the area of the core 22 is determined to be the same as that of the display panel in which pixels 28 are formed.

The light source 21 has a reflecting mirror 31 for focusing the light on the core 22 of the optical waveguide 20.

The light incident to the core 22 of the optical waveguide 20 propagates through the whole face of the core 22, and illuminates the whole pixels of the display panel.

At this time, the light source 21 may comprise a bar type fluorescent lamp.

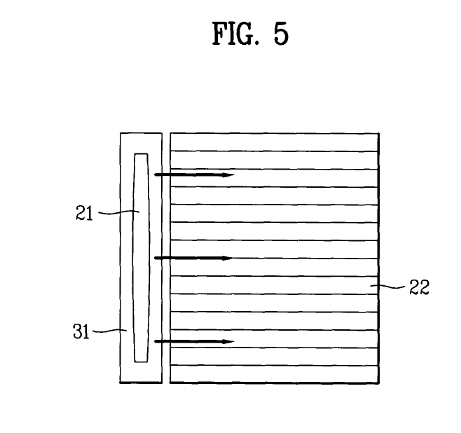

In the embodiment of FIG. 5, the light source of FIG. 4 is used, and a linear optical waveguide 20 is used.

The linear optical waveguide 20 has plural cores 22 for propagating the light, and the respective cores 22 are formed in the same direction so that they correspond to the first electrodes 25 of the display panel.

For example, in the case of a resolution of XGA (1024×768), the optical waveguide 20 should have 1024 or 768 cores so as to correspond to the pixels in a column direction.

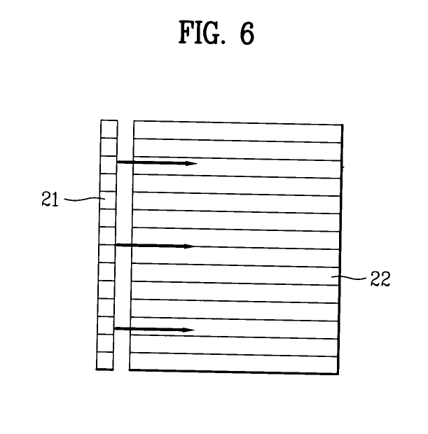

In the embodiment of FIG. 6, there are plural light sources 21, which are arranged so as to correspond to the respective cores 22 of the linear optical waveguide 20.

Meanwhile, on the upper part of the optical waveguide 20, the first and second electrodes 25 and 27 are formed, and between the first and second electrodes 25 and 27, the liquid crystals 26 having the hologram patterns are formed.

If a voltage is applied to the first and second electrodes 25 and 27 in accordance with an external video signal, the liquid crystals 26 display a color image by adjusting the quantity and wavelength of light to correspond to the video signal.

In the system according to the present invention, the hologram pattern of the liquid crystal formed in one pixel is different from the hologram pattern of the liquid crystal formed in its neighboring pixel.

If it is assumed that one pixel is divided into first to third sub-pixels, the hologram patterns of the liquid crystals formed in the respective sub-pixels are different from one another.

The liquid crystal of the first sub-pixel adjusts a quantity of transmitted light of a red light, the liquid crystal of the second sub-pixel adjusts a quantity of transmitted light of a green light, and the liquid crystal of the third sub-pixel adjusts a quantity of transmitted light of a blue light.

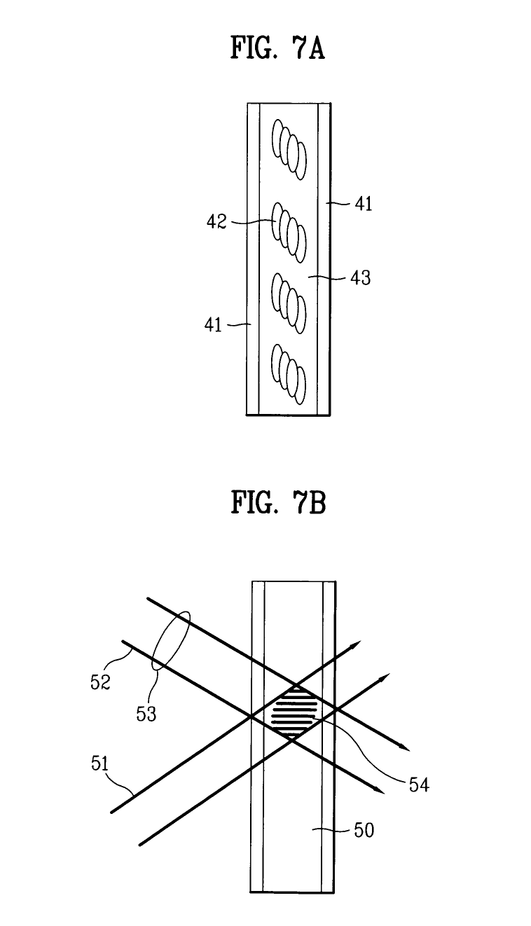

FIGS. 7A and 7B are views illustrating hologram patterns formed in the liquid crystal.

Generally, the liquid crystal of the hologram pattern, as shown in FIG. 7A, comprises liquid crystal molecules 42 which form the hologram pattern between the electrodes 41, and a monomer 43.

The liquid crystal molecules 42 and the monomer 43 are periodically arranged and have a band shape.

Also, the refraction index of the liquid crystal molecules 42 and the refraction index of the monomer 43 are different from each other to form a periodic refraction index lattice.

The hologram pattern liquid crystal constructed as above is formed as follows.

As shown in FIG. 7B, a laser reference light 51 and the laser light 52 are irradiated into a mixed liquid 50 of liquid crystal and monomer.

At this time, in the mixed liquid 50 of liquid crystal and monomer, a band-shaped interference pattern is formed due to the phase difference between the two laser lights, and this is called a hologram pattern 54.

Here, the thickness, period, etc., of the hologram pattern 54 can be adjusted by means of a diffractive element 53.

The diffractive element 53 may be a pattern made by a lens or a computer.

In the band-shaped hologram pattern 54, the monomer in a bright area of the mixed liquid 50 of the liquid crystal is polymerized by the light, and simultaneously the liquid crystal in the bright area is swept into a dark area.

The hologram pattern has an arrangement in which a bright polymer area and a dark liquid crystal area are periodically alternated due to the irradiation of the laser light, and forms a periodic refraction index lattice.

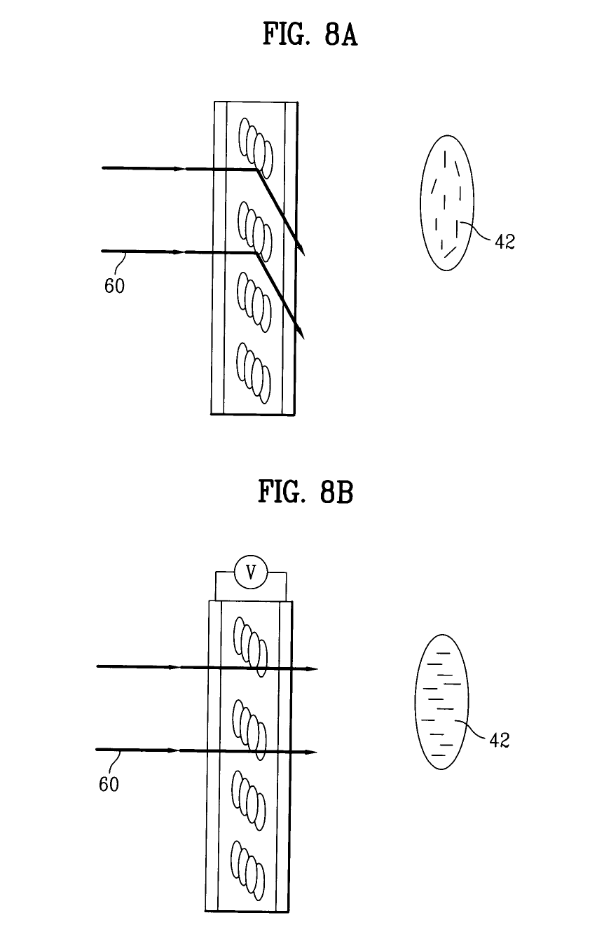

FIGS. 8A and 8B are views explaining the concept of driving a hologram pattern liquid crystal.

FIG. 8A shows the case that a voltage is not applied to the hologram pattern liquid crystal, and FIG. 8B shows the case that a voltage is applied to the hologram pattern liquid crystal.

As shown in FIG. 8A, if the voltage is not applied to the hologram pattern liquid crystal, the incident light 60 is diffracted by the refraction index lattice.

That is, the incident light 60 is diffracted by the Bragg phenomenon appearing in the lattice having a constant period.

If the voltage is not applied to the hologram pattern liquid crystal, the liquid crystal molecules 42 are arranged irregularly, the incident light cannot permeate the liquid crystal molecules, and the difference between the refraction index of the liquid crystal and the refraction index of the monomer is maintained.

Accordingly, the hologram pattern liquid crystal has the refraction index having a constant period, and the incident light is diffracted.

As shown in FIG. 8B, if the voltage is applied to the hologram pattern liquid crystal, the incident light 60 permeates the hologram pattern liquid crystal.

This is because the liquid crystal molecules 42 are arranged in the same direction by the applied voltage.

The refraction index of the liquid crystal molecules 42 and the refraction index of the monomer become identical by the arrangement of the liquid crystal molecules, and thus the refraction index lattice is not formed in the hologram pattern liquid crystal.

Accordingly, the incident light 60 directly permeates the hologram pattern liquid crystal.

Also, the quantity of transmitted light is adjusted in accordance with the level of the applied voltage.

Also, the wavelength of the incident light 60 has connection with the period of the refraction index lattice. Accordingly, by adjusting the period and space of the refraction index lattice, the light of a desired wavelength can selectively be obtained.

The method of driving the display system using the hologram pattern as constructed above according to the present invention will now be explained.

As shown in FIGS. 2 and 3, if a video signal is inputted to the control unit 30, the driving unit 29 applies a voltage to the corresponding pixels according to the video signal.

Then, if a voltage is applied to the liquid crystal 26 having the hologram pattern of the corresponding pixels 28, the liquid crystal molecules of the liquid crystal 26 are irregularly arranged to have a constant refraction index.

Since the refraction index is the same as the refraction index of the cladding 23 of the optical waveguide 20, the light traveling through the core 22 of the optical waveguide cannot permeate the liquid crystal 26.

Accordingly, the corresponding pixels cannot transmit the light, and thus implement a black picture.

If the voltage is not applied to the liquid crystal 26 having the hologram pattern of the corresponding pixels, the liquid crystal molecules 26 are arranged irregularly.

At this time, since the refraction index of the liquid crystal is different from the refraction index of the cladding 23, the light traveling through the core 22 of the optical waveguide permeate the liquid crystal 26.

Accordingly, the corresponding pixels transmit the light, and thus implement a white picture.

Meanwhile, in order to represent the gradation of the picture, it is required to adjust the quantity of light of the pixels.

In the present invention, the gradation of the picture can be represented by adjusting the transmission factor of the liquid crystal by adjusting the level of the voltage of the respective pixels.

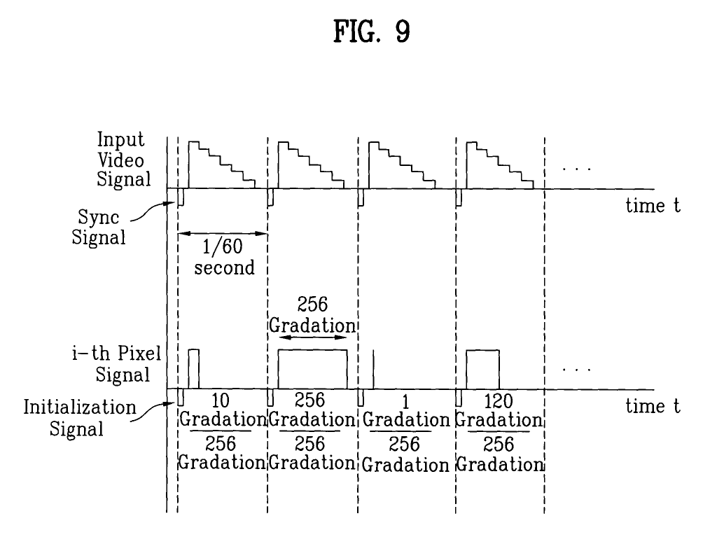

Meanwhile, as shown in FIG. 9, the quantity of light can be adjusted by adjusting the frequency of on/off operation of the respective pixels for a predetermined time.

FIG. 9 is a view illustrating the implementation of gradation of a hologram pattern liquid crystal according to time.

Specifically, the display system according to the present invention adopts 256 gradations, and applies ‘on’ signal to the respective pixel as many times as the gradations of the respective pixel for 60 Hz.

For example, if one pixel represents 10 gradations, the ‘on’ signal is applied to the pixel 10 times for 1/60 sec.

As described above, according to the present invention, the gradations can be implemented in an analog form by means of the level of the applied voltage and in a digital form by means of the frequency of applying the voltage.

That is, the present invention can adjust the transmission factor of the liquid crystal by the level of the applied voltage, and can adjust the quantity of light by the frequency of applying the voltage.

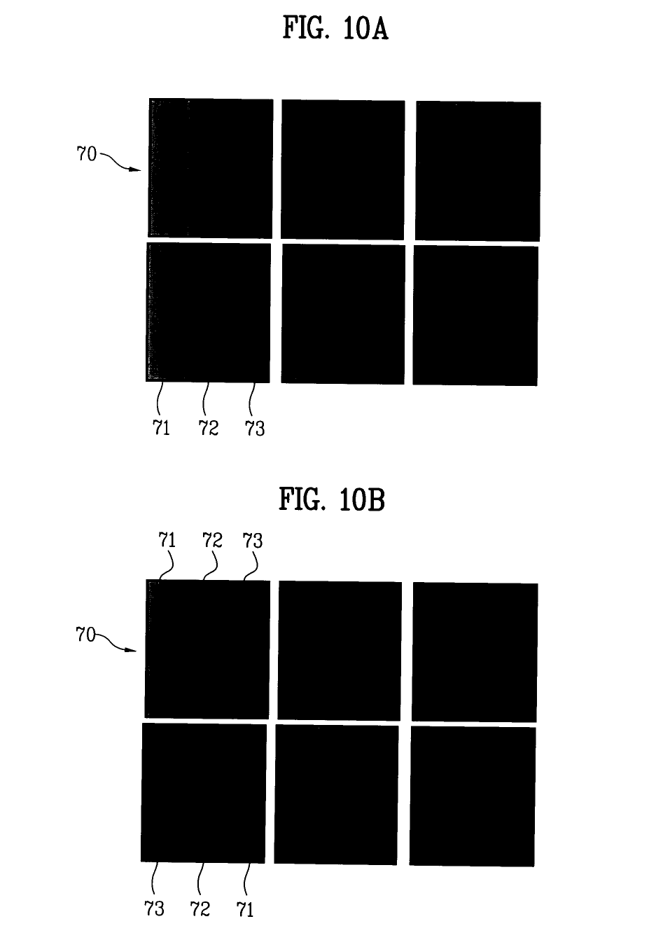

FIGS. 10A and 10B are views illustrating the implementation of color of a hologram pattern liquid crystal.

As shown in FIGS. 10A and 10B, according to the present invention, one pixel 70 can be divided into three sub-pixels 71, 72 and 73 in order to implement the color image.

At this time, the hologram patterns of the liquid crystals formed on the respective sub-pixels are different from one another.

The liquid crystal of the first sub-pixel 71 adjusts a quantity of transmitted light of a red light, the liquid crystal of the second sub-pixel 72 adjusts a quantity of transmitted light of a green light, and the liquid crystal of the third sub-pixel adjusts 73 a quantity of transmitted light of a blue light.

FIG. 10B shows the sub-pixels of the respective pixel 70 arranged to cross each other in order to prevent the respective sub-pixels from being separately seen due to a large gap among the sub-pixels of FIG. 10A.

As described above, the display system using a hologram pattern liquid crystal according to the present invention has the following effects:

First, since the present invention does not use the polarization plates and so on, the loss of light is reduced, and the brightness of the picture can be increased by effectively controlling the light.

Second, since the present invention does not require the components such as the color filter, the manufacturing process is simplified, and a super-thin display system can be implemented.

Third, since the reflective mirror is used in the optical waveguide path, the use efficiency of the light can be heightened.

It will be apparent to those skilled in the art than various modifications and variations can be made in the present invention. Thus, it is intended that the present invention covers the modifications and variations of this invention provided they come within the scope of the appended claims and their equivalents.

What is claimed is:

1. A display system using a hologram pattern liquid crystal comprising:
a plurality of first electrodes formed in line in the same direction;
a plurality of second electrodes formed in line in a direction perpendicular to the first electrodes;
liquid crystals having hologram patterns formed in a pixel area between the first and second electrodes;
an optical waveguide for transferring light to the pixel area; and
a light source, located in a side area of the optical waveguide, for generating the light.

2. The display system of claim 1, further comprising:
a driving unit for driving the first and second electrodes; and
a control unit for controlling the driving unit in accordance with a video signal inputted from the outside.

3. The display system of claim 1, wherein the first and second electrodes are transparent electrodes.

4. The display system of claim 1, wherein the hologram pattern of the liquid crystal which is formed in one pixel is different from the hologram pattern of the liquid crystal which is formed in its neighboring pixel.

5. The display system of claim 1, wherein one pixel is divided into first, second and third sub-pixels, and the hologram patterns of the liquid crystals formed in the respective sub-pixels are different from one another.

6. The display system of claim 5, wherein the liquid crystal of the first sub-pixel adjusts a quantity of transmitted light of a red light, the liquid crystal of the second sub-pixel adjusts a quantity of transmitted light of a green light, and the liquid crystal of the third sub-pixel adjusts a quantity of transmitted light of a blue light.

7. The display system of claim 1, wherein the liquid crystal comprises liquid crystal molecules having the hologram pattern and a monomer, and the liquid crystal molecules and the monomer are periodically arranged and have a shape of a band.

8. The display system of claim 7, wherein the hologram pattern is a band-shaped interference pattern formed by a phase difference between a laser reference light and the laser light which are irradiated on a mixed liquid of the liquid crystal molecules and the monomer.

9. The display system of claim 1, wherein the light source is one of a high-voltage mercury lamp, a metal halide lamp, and a white LED.

10. The display system of claim 1, wherein one light source is provided, and a length of the light source is the same as a length of a side face of the optical waveguide.

11. The display system of claim 1, wherein plural light sources are provided, and the respective light sources are arranged corresponding to cores of the optical waveguide.

12. The display system of claim 1, wherein the optical waveguide is located on a lower part of the first electrode.

13. The display system of claim 1, wherein the light source is located in a side area of the optical waveguide, and a reflecting mirror is located on the other side face of the optical waveguide.

14. The display system of claim 1, wherein the optical waveguide has one core for propagating the light, and an area of the core is the same as an area of the display panel having the pixels formed thereon.

15. The display system of claim 1, wherein the optical waveguide has plural cores for propagating the light, and the respective cores are formed in the same direction so as to correspond to the first electrodes.
